(19) United States
(12) Patent Application Publication
(10) Pub. No.: US 2019/0250600 A1
(43) Pub. Date: Aug. 15, 2019

(54) CONSUMABLE/WEAR PART MANAGEMENT DEVICE AND CONSUMABLE/WEAR PART MANAGEMENT PROGRAM

(71) Applicant: DENSO CORPORATION, Kariya-city, Aichi-pref. (JP)

(72) Inventor: Tatsuya HAYASHI, Kariya-city (JP)

(21) Appl. No.: 16/317,062

(22) PCT Filed: May 16, 2017
(86) PCT No.: PCT/JP2017/018354

§ 371 Date: Jan. 11, 2019

(30) Foreign Application Priority Data
Jul. 19, 2016 (JP) 2016-141350

(51) Int. Cl. G05B 23/02; G07C 5/00

(52) U.S. Cl. CPC G05B 23/0283; G05B 23/0267; G07C 5/006

(57) ABSTRACT

A consumable/wear part management device acquires a consumed/worn state of consumable/wear parts and determines whether there is a consumable/wear part needing maintenance. In case of a determination that there is a consumable/wear part needing maintenance, the consumable/wear part management device specifies a maintenance timing at which the maintenance is needed, determines a level of margin until the specified maintenance timing, and determines whether a driver is a vehicle administrator. In case of a determination that the level of margin is equal to or higher than a prescribed value, the consumable/wear part management device notifies the driver of maintenance information if the driver is the vehicle administrator, and does not notify the driver of the maintenance information if the driver is other than the vehicle administrator. In case that the level of margin is lower than the prescribed value, the consumable/wear part management device notifies the driver of the maintenance information regardless of whether the driver is the vehicle administrator.

### CROSS REFERENCE TO RELATED APPLICATION

The present application is based on Japanese Patent Application No. 2016-141350 filed on Jul. 19, 2016, the whole contents of which are incorporated herein by reference.

### TECHNICAL FIELD

The present disclosure relates to a consumable/wear part management device and a consumable/wear part management program.

### BACKGROUND ART

A consumable/wear part management device for managing consumable/wear parts of a vehicle is proposed. The consumable/wear part management device of this kind acquires a consumed/worn state of the consumable/wear part and, when it is determined that there is a consumable/wear part needing maintenance, notifies maintenance information advising an execution of maintenance (for example, refer to patent literature 1).

### PRIOR ART LITERATURES

### Patent Literature

Patent Literature 1: JP 2006-21570A

### SUMMARY OF INVENTION

According to the configuration disclosed in patent literature 1, maintenance information is notified to a driver or shop employee of a nearby gas station, automotive parts shop, car dealer and the like. In most cases, it is a vehicle administrator, which is an owner of a vehicle, who executes the maintenance actually. For this reason, in case that a driver is other than a vehicle administrator, it is likely that the maintenance information is not notified to the vehicle administrator even if the maintenance information is notified to the driver. As a result, the maintenance will not be executed possibly even when it becomes maintenance timing to execute the maintenance.

It is advisable to avoid possibility that the maintenance information is not notified to the vehicle administrator inadvertently, by notifying the vehicle administrator of the maintenance information not immediately before the maintenance timing but frequently well in advance of the maintenance timing. In this case, the frequency of notification of the maintenance information increases. Such frequent notifications are not so bothering in case that the driver is the vehicle administrator but are often bothering in case that the driver is other than the vehicle administrator.

It is an object of the present disclosure to provide a consumable/wear part management device and a consumable/wear part management program which are capable of properly notifying a vehicle administrator of maintenance information and advising the vehicle administrator to properly execute maintenance.

According to one aspect of the present disclosure, a state acquisition part acquires a consumed/worn state of a consumable/wear part. A maintenance need determination part determines whether there is any consumable/wear part needing maintenance based on the consumed/worn state. In case of a determination that there is a consumable/wear part needing maintenance, a level of margin determination part specifies maintenance timing for maintenance of such a consumable/wear part and determines a level of margin until the specified maintenance timing. A driver determination part determines whether a driver is a vehicle administrator. A notification control unit notifies maintenance information of the consumable/wear part needing maintenance. In case that the level of margin is equal to or more than a prescribed value, the notification control unit notifies the maintenance information of the consumable/wear part needing maintenance if the driver is the vehicle administrator but does not notify the maintenance information if the drive is other than the vehicle administrator.

Under a state that the level of margin until the maintenance timing is comparatively high and urgency of the maintenance is comparatively low, the notification control unit notifies the maintenance information if the driver is the vehicle administrator. If the driver is other than the vehicle driver, the notification control unit does not notify the maintenance information. Thus, it is possible to avoid possibility that the driver other than the vehicle administrator feels the notification of the maintenance information to be bothering. Under a state that the level of margin until the maintenance timing is comparatively low and the urgency of maintenance is comparatively high, the notification control unit notifies the maintenance information regardless of whether the driver is the vehicle administrator. In case that the driver is the vehicle administrator, it is possible to directly advise the vehicle administrator to execute the maintenance. Even in case that the driver is not the vehicle administrator, it is possible to indirectly advise the vehicle administrator to execute the maintenance through the driver other than the vehicle administrator. It is thus possible to notify the vehicle administrator of the maintenance information thereby to advise the vehicle administrator to execute the maintenance properly.

### BRIEF DESCRIPTION OF DRAWINGS

The above and other objects as well as features and advantages of the present disclosure will become clearer by the following detailed description made with reference to the accompanying drawings. In the drawings:

FIG. 1 is a functional block diagram showing one embodiment;

FIG. 2 is a flowchart (part 1);

FIG. 3 is a flowchart (part 2);

FIG. 4 is an illustration of notification state of maintenance information (part 1);

FIG. 5 is an illustration of notification state of maintenance information (unit 2);

FIG. 6 is an illustration of notification state of maintenance information (part 3);

FIG. 7 is an illustration of notification state of maintenance information (part 4);

FIG. 8 is an illustration of notification state of maintenance information (part 5); and

FIG. 9 is an illustration of notification state of maintenance information (part 6).

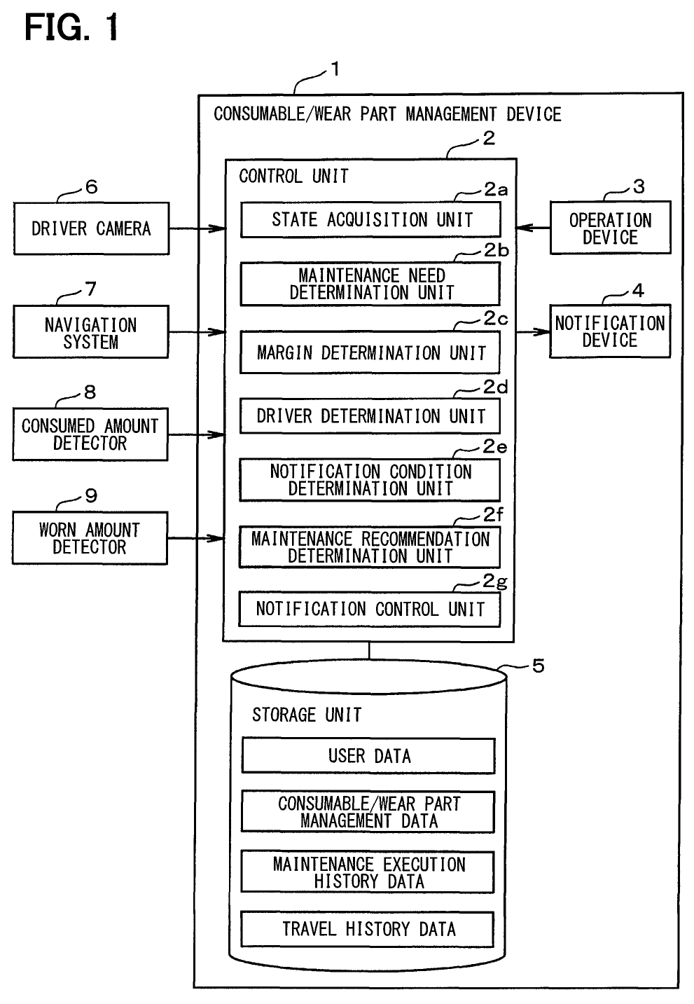

### EMBODIMENT FOR CARRYING OUT INVENTION

One embodiment will be described below with reference to the drawings. A consumable/wear part management device 1 manages consumable/wear parts of a vehicle and, in case of a determination that there is a consumable/wear part needing maintenance, notifies maintenance information which advises execution of maintenance of such a consumable/wear part. The consumable/wear part includes a consumable/wear part such as gasoline, coolant water, window washer fluid, oil, battery and tire, which consumes by use, and a wear part such as a wiper blade, air filter, oil element, fan belt, timing belt and a brake pad, which wears by use or deteriorates by aging variation. These consumable/wear parts have respective important roles for proper and safe travel of a vehicle and need be subjected to maintenance. The maintenance includes refilling, exchange and inspection. The maintenance should be executed after one month and six months from a purchase of a vehicle, at every prescribed period of vehicle use and at every prescribed travel distance.

The consumable/wear part maintenance device 1 includes a control unit 2, an operation device 3, a notification device 4 and a storage part 5. The operation device 3 is a touch key and the like formed on a display of a navigation system, for example, and outputs to the control unit 2 an operation signal indicating a received operation upon receiving an operation of a driver. The notification device 4 has a display device and a voice output device. The display device is, for example, a display panel of the navigation system. The voice output device is, for example, a speaker of the navigation system. The notification device 4 notifies maintenance information in response to an input of a notification command signal from the consumable/wear part management device 1.

The storage unit 5 is, for example, a memory device such as a hard disk drive and configured to store user data, consumable/wear part management data, maintenance execution data and travel history data. The user data is for verification of a user who will be a driver. The consumable/wear part management data indicates a determination reference for determining whether each consumable/wear part needs maintenance. The maintenance execution history data indicates a history of maintenance executed for each consumable/wear part. The travel history data indicates a travel history such as a travel distance of a vehicle and a driving operation of a driver.

A driver camera 6 is a CCD (charge coupled device), image sensor, CMOS (complementary metal oxide semiconductor) image sensor and the like. The driver camera takes a picture image of a face of a driver seated on a driver's seat and outputs an image signal including the taken image to the consumable/wear part management device 1. The driver camera 6 may be only one or plural. A navigation system 7 has conventional functions such as a function of detecting a present position of a vehicle and a function of storing a registration position of a driver's home and outputs navigation signals related to navigation to the consumable/wear part management device 1. The navigation system 7 further outputs an IG signal indicating an ON/OFF state of an IG (ignition) switch to the consumable/wear part management device 1.

A consumed amount detector 8 is a device for detecting a consumed amount of a consumable/wear part. The consumed amount detector 8 detects a consumed amount of the consumable/wear part such as gasoline, coolant water, window washer fluid, oil, battery and tire described above and outputs a consumed amount detection signal indicating a detected consumed amount to the consumable/wear part management device 1. The consumed amount detector 8 is, for example, a fluid level meter for measuring fluid level of gasoline, coolant water, window washer fluid or oil, a charge meter for measuring a charge/discharge state of a battery, a slip sign detection sensor for detecting a slip sign of a tire and a tire depth gauge for measuring a depth of tire groove.

A worn amount detector 9 is a device for detecting a worn amount of a worn part. The worn amount detector 9 detects a worn amount of a worn part such as a wiper blade, air filter, oil element, fan belt, timing belt and a brake pad and outputs a worn amount detection signal indicating a detected worn amount to the consumable/wear part management device 1. The worn amount detector 9 is a device for accumulating a period of use and a travel distance of use of a device related to a wear part such as a wiper having a wiper blade, an air conditioner having an air filter, an oil lubricating device having an oil element, a fan having a fan belt, an engine valve mechanism having a timing belt and a brake device having a brake pad.

The control unit 2 is formed of a microcomputer having a CPU (central processing unit), a ROM (read only memory), a RAM (random access memory) and an I/O (input/output). The control unit 2 controls a whole operation of the consumable/wear part management device 1 by executing a computer program stored in a non-transitive tangible storage medium thereby executing processing corresponding to such a computer program.

The control unit 2 includes a state acquisition unit 2a, a maintenance need determination unit 2b, a margin determination unit 2c, a driver determination unit 2c, a notification condition determination unit 2e, a maintenance recommendation determination unit 2f and a notification control unit 2g. These units 2a to 2g are provided by a consumable/wear part management program executed by the control unit 2 and realized by software.

The state acquisition unit 2a acquires a consumed/worn state of the consumable/wear part based on the consumed amount detection signal received from the consumed amount detector 8 and the worn amount detection signal received from the consumed amount detector 8. The maintenance need determination unit 2b determines whether there is any consumable/wear part needing maintenance by comparing the consumed/worn state acquired by the state acquisition unit 2a with consumable/wear part management data. The maintenance need determination unit 2b determines that the window washer fluid need be refilled, when a fluid amount of the window washer fluid indicated by the consumed amount detection signal reaches to be less than a prescribed amount prescribed by the consumable/wear part management data, for example. Further, the maintenance need determination unit 2b determines that the oil element need be exchanged, when a use period or a use travel distance of the oil element indicated by the worn amount detection signal reaches to be more than a prescribed period or prescribed travel distance prescribed by the consumable/wear part management data, for example.

The margin determination unit 2c specifies a maintenance timing at which maintenance is needed, when it is determined that there is a consumable/wear part which needs maintenance. In case of a fluid amount of the window washer fluid, for example, the margin determination unit 2c specifies the maintenance timing to be after a prescribed number of days from time when the window washer fluid decreased to be less than a prescribed amount. In this case, the margin determination unit 2c may determine the prescribed number of days by using the travel history data. For example, in case that the window washer fluid was used comparatively frequently in the past and will be assumed to be used frequently similarly in the future, the prescribed number of days may be set to be comparatively less. On the contrary, in case that the window washer fluid was used comparatively infrequently in the past and will be assumed to be used infrequently similarly in the future, the prescribed number of days may be set to be comparatively more. In case of a use period or a use travel distance of the oil element, for example, the margin determination unit 2c specifies the maintenance timing to be after a prescribed number of days from time when the use period or the use travel distance reached to be more than a prescribed period or prescribed travel distance. In this case, the margin determination unit 2c may determine the prescribed number of days by using the travel history data. For example, in case that the vehicle was used comparatively frequently in the past and will be assumed to be used frequently similarly in the future, the prescribed number of days may be set to be comparatively less. On the contrary, in case that the vehicle was used comparatively infrequently in the past and will be assumed to be used infrequently similarly in the future, the prescribed number of days may be set to be comparatively more. Further, the margin determination unit 2c may determine the prescribed number of days by using the maintenance execution history data.

By thus specifying the maintenance timing, the margin determination unit 2c determines a level of margin until the specified maintenance timing. The margin determination unit 2c determines whether a level of margin until the maintenance timing is sufficiently long by quantizing the level of margin until the maintenance timing and comparing it with a prescribed value. That is, the margin determination unit 2c determines that urgency of maintenance is comparatively low and the level of margin is comparatively high if the level of margin until the maintenance timing is equal to or longer than a prescribed value. On the contrary, the margin determination unit 2c determines that the urgency of maintenance is comparatively high and the level of margin is comparatively low if the level of margin until the maintenance timing is shorter than the prescribed value. The margin determination unit 2c similarly determines levels of margin until the maintenance timings of the consumable/wear parts other than the window washer fluid and the oil element.

The driver determination unit 2d determines whether a driver is a vehicle administrator by receiving the image signal from the driver camera 6a, extracting characteristic features of a face of the driver (for example, outline and positions of eyes, nose, mouth and ears) by analyzing an image included in the image signal and comparing the characteristic features of the face of the driver with the user data. The driver determination unit 2d determines that the driver is the vehicle administrator in case that a rate of coincidence between the characteristic features of the face of the driver and characteristic features of the face of the vehicle administrator pre-registered in the user data is equal to or more than a prescribed value. The driver determination unit 2d determines that the driver is other than the vehicle administrator in case that the rate of coincidence is less than the prescribed value. The driver determination unit 2d acquires such determination results as driver information. The vehicle administrator is a person who is registered as an owner of the vehicle in an owner's name column of a certificate of a vehicle inspection, for example, and hence highly likely to execute maintenance actually.

The notification condition determination unit 2e determines whether a notification condition is satisfied by using the navigation signal and the IG signal received from the navigation system 7. The notification condition determination unit 2e determines that the notification condition is satisfied when, for example, it is within a prescribed time after a switchover of the IG signal from OFF to ON, that is, a driver's operation to start driving, and the present position of the vehicle is the pre-registered registration position.

The maintenance recommendation determination unit 2f determines whether there is any consumable/wear part for which maintenance is recommended with respect to consumable/wear parts other than the consumable/wear part needing maintenance. The consumable/wear part recommended for maintenance is a consumable/wear part which is not determined to be subjected to maintenance at the maintenance timing specified for the above-described consumable/wear part needing maintenance but is highly likely to be determined to be subjected to maintenance in the near future. The notification control unit 2g outputs a notification command signal to the notification device 4 so that the notification device 4 notifies the maintenance information of the consumable/wear part needing maintenance as needed maintenance information and the maintenance information of the consumable/wear part recommended for maintenance as recommended maintenance information.

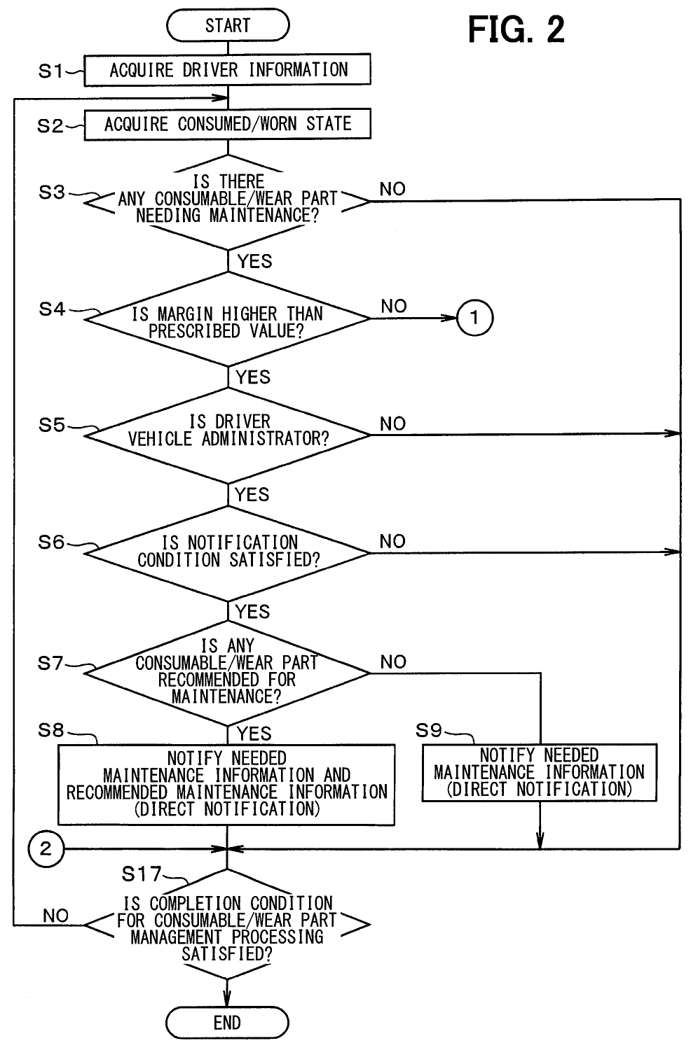

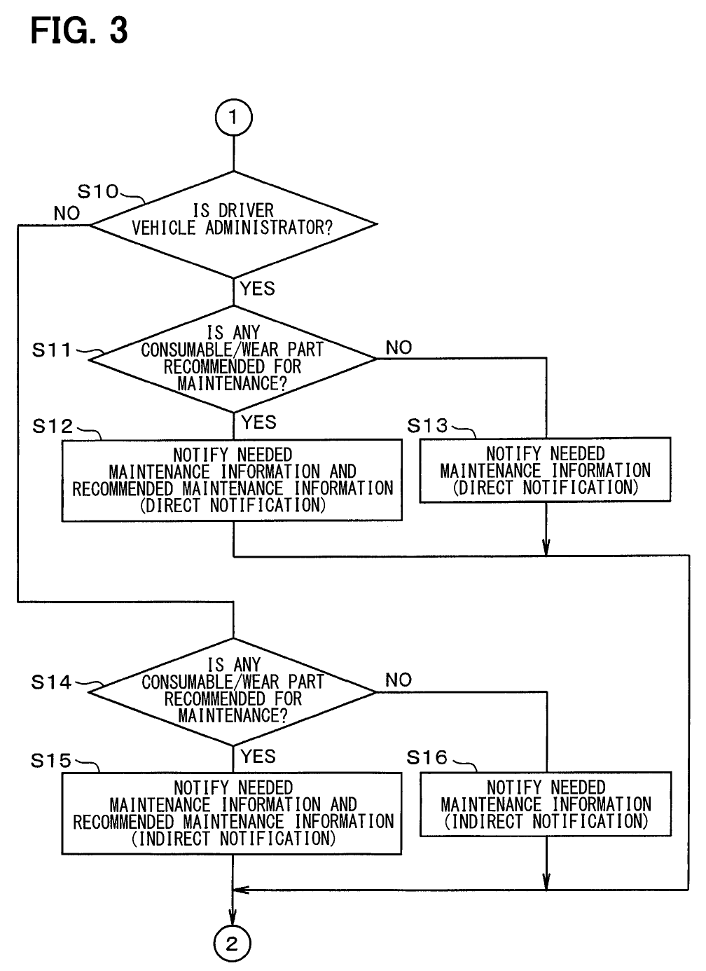

An operation of the configuration described above will be described next with reference to FIG. 2 to FIG. 9.

The control unit 2 executes consumable/wear part management processing. The control unit 2 starts the consumable/wear part management processing when a start condition for the consumable/wear part management processing is satisfied. The control unit 2 compares the characteristic features of the driver with the user data by using the image signal received from the driver camera 6 and acquires the driver information indicating whether the driver is the vehicle administrator (S1). The control unit 2 acquires the consumed/worn state of the consumable/wear part based on the consumed amount detection signal received from the consumed amount detector 8 and the worn amount detection signal received from the worn amount detector 9 (S2 corresponding to state acquisition processing). The control unit 2 determines whether there is any consumable/wear part needing maintenance by comparing the acquired consumed/worn state with the consumable/wear part management data (S3 corresponding to maintenance need determination processing). The control unit 2 specifies the maintenance timing, when it is determined that there is a consumable/wear part which needs maintenance (S3: YES) and determines the level of margin until the specified maintenance timing (S4 corresponding to margin determination processing).

In case of a determination that the level of margin until the maintenance timing is equal to or more than the prescribed value (S4: YES), the control unit 2 determines whether the driver is the vehicle administrator (S5 corresponding to driver determination processing). In case of a determination that the driver is the vehicle administrator (S5: YES), the control unit 2 determines whether the notification condition is satisfied (S6). In case of a determination that the notification condition is satisfied (S6: YES), the control unit 2 determines whether there is any consumable/wear part recommended for maintenance (S7 corresponding to maintenance recommendation determination processing).

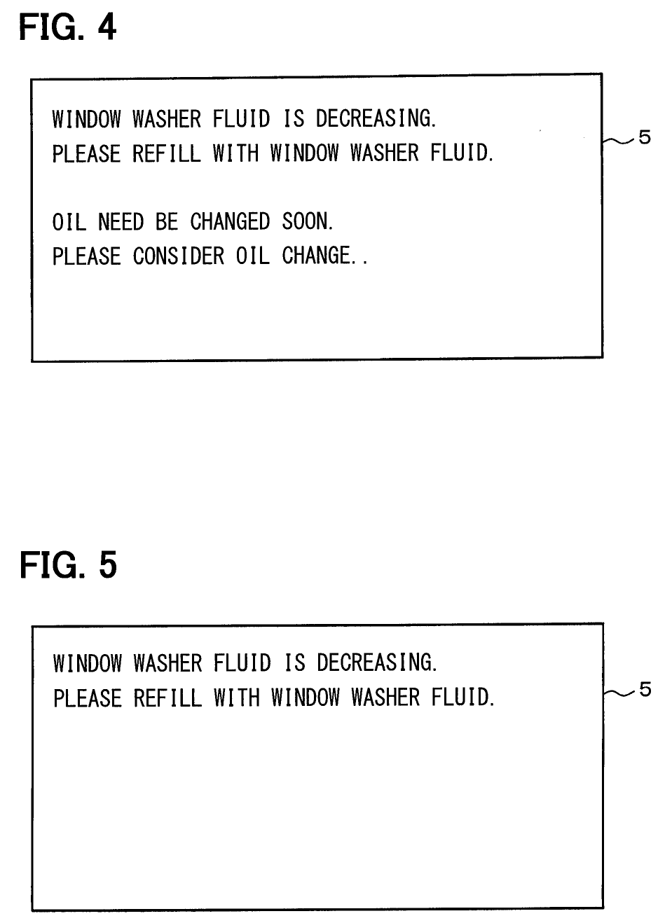

In case of a determination that there is the consumable/wear part recommended for maintenance (S7: YES), the control unit 2 outputs the notification command signal to notify the maintenance information of the consumable/wear part needing maintenance and the maintenance information of the consumable/wear part recommended for maintenance from the notification device 4 (S8 corresponding to notification control processing). That is, in case that there is a consumable/wear part recommended for maintenance, that is, a consumable/wear part which needs maintenance but its level of margin until the maintenance timing is comparatively high, the control unit 2 controls the notification device 4 to notify the maintenance information indicating such a determination. In this case, since the driver is determined to be the vehicle administrator, the control unit 2 directly notifies the maintenance information advising the execution of maintenance. In case that the notification device 4 is a display device, for example, and the control unit 2 determines that the window washer fluid is determined to be the consumable/wear part needing maintenance and the oil is determined to be the consumable/wear part recommended for maintenance, the control unit 2 controls the notification device 4 to display the following messages, for example, as shown in FIG. 4. “Window washer fluid is decreasing. Please refill with window washer fluid. Oil need be changed soon. Please consider oil change.”

In case of a determination that there is no consumable/wear part recommended for maintenance (S7: NO), the control unit 2 outputs the notification command signal to the notification device 4 and controls the notification device 4 to notify the maintenance information indicating the consumable/wear part needing maintenance (S9 corresponding to notification control processing). That is, in case that there is a consumable/wear part needing maintenance, the level of margin of the consumable/wear part until the maintenance timing is comparatively high and there is no consumable/wear part recommended for maintenance, the control unit 2 controls the notification device 4 to notify the maintenance information indicating such a state. In this case as well, since the driver is determined to be the vehicle administrator, the control unit 2 notifies the maintenance information, which directly advises the execution of maintenance. In case that the notification device 4 is a display device, for example, and the control unit 2 determines that the window washer fluid is determined to be the consumable/wear part needing maintenance, the control unit 2 controls the notification device 4 to display the following message, for example, as shown in FIG. 5. “Window washer fluid is decreasing. Please refill with window washer fluid.”

In case of a determination that the driver is other than the vehicle administrator (S5: NO) or that the notification condition is not satisfied (S6: NO) in spite of the determination that the driver is the vehicle administrator (S5: YES), the control unit 2 controls the notification device 4 not to notify the maintenance information.

In case of a determination that the level of margin until the maintenance timing is less than the prescribed value (S4: NO), the control unit 2 determines whether the driver is the vehicle administrator (S10 corresponding to driver determination processing). In case of a determination that the driver is the vehicle administrator (S10: YES), the control unit 2 determines whether there is any consumable/wear part recommended for maintenance (S11: corresponding to maintenance recommendation determination processing).

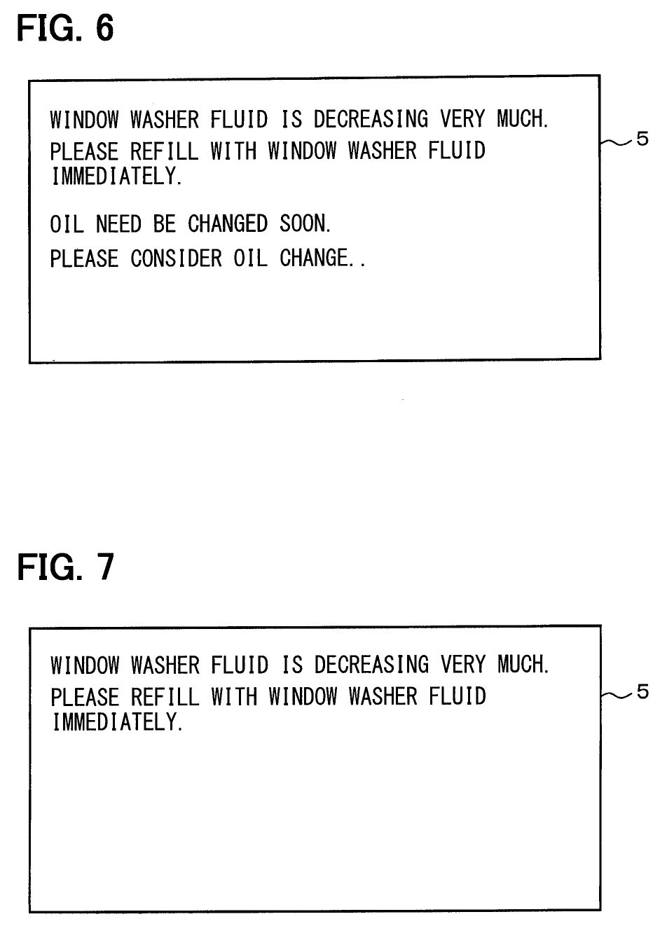

In case of a determination that there is a consumable/wear part recommended for maintenance (S11: YES), the control unit 2 output the notification command signal to the notification device 4 and controls the notification device 4 to notify the maintenance information indicating the consumable/wear part needing maintenance and the maintenance information indicating the consumable/wear part recommended for maintenance (S12 corresponding to notification control processing). That is, in case that there is the consumable/wear part needing maintenance and its level of margin until the maintenance timing is comparatively low and that there is further the consumable/wear part recommended for maintenance, the control unit 2 controls the notification device 4 to notify the maintenance information indicating such a state. In this case as well, since the driver is determined to be the vehicle administrator, the control unit 2 notifies the maintenance information, which directly advises the execution of maintenance. In case that the notification device 4 is a display device, for example, and the control unit 2 determines that the window washer fluid is determined to be the consumable/wear part needing maintenance and the oil is determined to be the consumable/wear part recommended for maintenance, the control unit 2 controls the notification device 4 to display the following message, for example, as shown in FIG. 6. “Window washer fluid is decreasing. Please refill with window washer fluid immediately.” “Oil need be exchanged soon. Please consider exchange of oil.” That is, the control unit 2 controls the notification device 4 to display a message which has higher urgency than that of the message shown in FIG. 4.

In case of a determination that there is no consumable/wear part recommended for maintenance (S11: NO), the control unit 2 outputs the notification command signal to the notification device 4 and controls the notification device 4 to notify the maintenance information of the consumable/wear part needing maintenance (S13 corresponding to notification control processing). That is, in case that there is the consumable/wear part needing maintenance and its level of margin until the maintenance timing is comparatively low and that there is no consumable/wear part recommended for maintenance, the control unit 2 controls the notification device 4 to notify the maintenance information indicating such a state. In this case as well, since the driver is determined to be the vehicle administrator, the control unit 2 notifies the maintenance information, which directly advises the execution of maintenance. In case that the notification device 4 is a display device, for example, and the control unit 2 determines that the window washer fluid is determined to be the consumable/wear part needing maintenance, the control unit 2 controls the notification device 4 to display the following message, for example, as shown in FIG. 7. “Window washer fluid is decreasing very much. Please refill with window washer fluid immediately.”

In case of a determination that the driver is not the vehicle administrator and the driver is other than the vehicle administrator (S10: NO), the control unit 2 determines whether there is any consumable/wear part recommended for maintenance (S14 corresponding to maintenance recommendation determination processing).

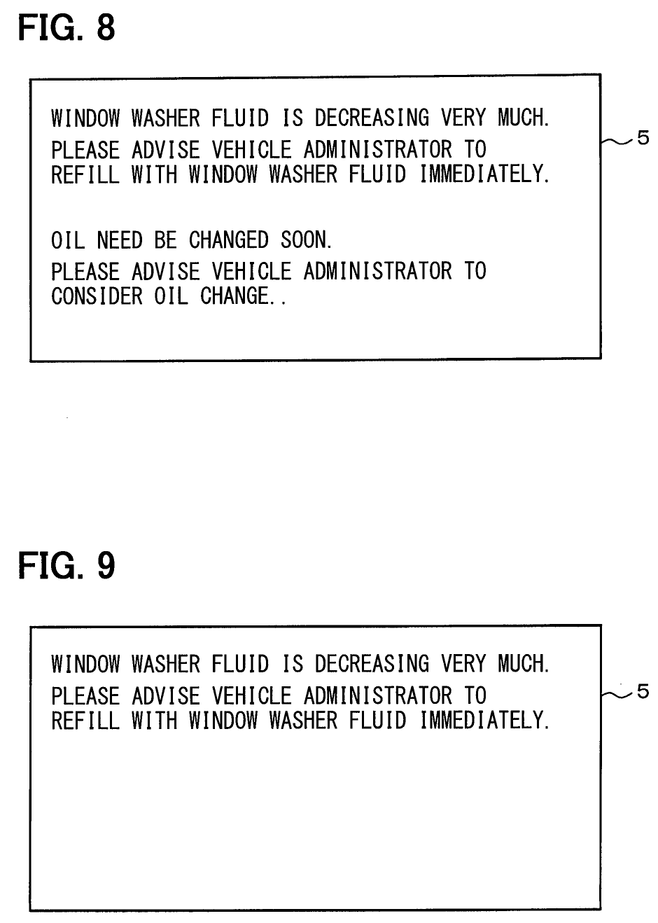

In case of a determination that there is a consumable/wear part recommended for maintenance (S14: YES), the control unit 2 outputs the notification command signal to the notification device 4 and controls the notification device 4 to notify the maintenance information indicating the consumable/wear part needing maintenance and the maintenance information indicating the consumable/wear part recommended for maintenance (S15 corresponding to notification control processing). That is, in case that there is the consumable/wear part needing maintenance and its margin until the maintenance timing is comparatively low and that there is further the consumable/wear part recommended for maintenance, the control unit 2 controls the notification device 4 to notify the maintenance information indicating such a state. In this case, since the driver is determined to be other than the vehicle administrator, the control unit 2 notifies the maintenance information, which indirectly advises the execution of maintenance. In case that the notification device 4 is a display device, for example, and the control unit 2 determines that the window washer fluid is determined to be the consumable/wear part needing maintenance and the oil is determined to be the consumable/wear part recommended for maintenance, the control unit 2 controls the notification device 4 to display the following message, for example, as shown in FIG. 8. “Window washer fluid is decreasing very much. Please advise the vehicle administrator to refill with window washer fluid immediately. Oil need be exchanged soon. Please advise the vehicle administrator to consider oil change.”

In case of a determination that there is no consumable/wear part recommended for maintenance (S14: NO), the control unit 2 outputs the notification command signal to the notification device 4 and controls the notification device 4 to notify the maintenance information indicating the consumable/wear part needing maintenance (S16 corresponding to notification control processing). That is, in case that there is the consumable/wear part needing maintenance and its level of margin until the maintenance timing is comparatively low and that there is no consumable/wear part recommended for maintenance, the control unit 2 controls the notification device 4 to notify the maintenance information indicating such a state. In this case as well, since the driver is determined to be other than the vehicle administrator, the control unit 2 notifies the maintenance information, which indirectly advises the execution of maintenance. In case that the notification device 4 is a display device, for example, and the control unit 2 determines that the window washer fluid is determined to be the consumable/wear part needing maintenance, the control unit 2 controls the notification device 4 to display the following message, for example, as shown in FIG. 9. “Window washer fluid is decreasing very much. Please advise the vehicle administrator to refill with window washer fluid immediately.”

In case that the control unit 2 determines whether a completion condition for completing the consumable/wear part management processing is satisfied (S17) and determines that the completion condition of the consumable/wear part management processing is not satisfied (S17: NO), the control unit 2 repeats executing step S2 and subsequent steps. In case that the control unit 2 determines that the completion condition of the consumable/wear part management processing is satisfied (S17: YES), the control unit 2 finishes the consumable/wear part management processing.

As described above, the present embodiment provides the following advantages.

Under the state that the level of margin until the maintenance timing is comparatively high and the urgency of maintenance is relatively low, the consumable/wear part management device 1 notifies the maintenance information in case that the driver is the vehicle administrator but does not notify the maintenance information in case that the driver is other than the vehicle administrator. It is thus possible to avoid that the driver other than the vehicle administrator feels the notification of maintenance bothering. Under the state that the level of margin until the maintenance timing is comparatively low and the urgency of maintenance is relatively high, the consumable/wear part management device 1 notifies the maintenance information regardless of whether the driver is the vehicle administrator. It is possible to directly advise the vehicle administrator to execute the maintenance in case that the driver is the vehicle administrator and to indirectly advise the vehicle administrator to execute the maintenance through the driver other than the vehicle administrator in case that the driver is other than the vehicle administrator. It is thus possible to properly notify the vehicle administrator of the maintenance information so that the vehicle administrator executes the maintenance.

Under the state that the level of margin until the maintenance timing is comparatively low, the consumable/wear part management device 1 notifies the vehicle administrator of the maintenance information advising the execution of maintenance directly in case that the driver is the vehicle administrator and notifies the vehicle administrator of the maintenance information advising the execution of maintenance indirectly. By thus categorizing the maintenance information based on whether the driver is the vehicle administrator, it is possible to properly notify the vehicle administrator of the maintenance information and properly advise the vehicle administrator to execute the maintenance.

Under the state that the level of margin until the maintenance timing is comparatively high, the consumable/wear part management device 1 notifies the maintenance information on condition that it is within the prescribed time after the driver made the driving start operation and the present position of the vehicle is the pre-registered registration position. It is thus possible to notify the maintenance information at the timing that the vehicle administrator started to drive the vehicle as far as the home is pre-registered as the registration position.

In addition to the notification of the maintenance information about the consumable/wear part needing maintenance, the consumable/wear part management device 1 notifies the maintenance information about the consumable/wear part recommended for maintenance in case of the determination that there is the consumable/wear part recommended for maintenance. It is thus possible to advise execution of combined maintenance of plural consumable/wear parts so that the maintenance is executed efficiently.

The present disclosure described above in respect of the embodiment is not limited to the disclosed embodiment and configuration. The present disclosure includes various modifications and variation within equivalent scopes. In addition, the present disclosure includes various combinations and forms as well as other combinations and forms, to which only one or more or less than that are added.

In the embodiment, the maintenance information is notified on condition that the notification condition is satisfied in case that the level of margin is equal to or more than the prescribed value and the driver is the vehicle administrator. However, the maintenance information may be notified on condition that the notification condition is satisfied even in case that the level of margin is less than the prescribed value regardless of whether the driver is the vehicle administrator.

In the embodiment, the notification condition is satisfied when it is within the prescribed time after the driver started the vehicle driving operation and the present position of the vehicle is the pre-registered registration position. However, the notification condition is set to any other conditions. For example, in case that the notification condition is set to the driving finishing operation of the driver, the maintenance information may be notified at a timing of arriving at home and getting off of the vehicle administrator as far as the home is pre-registered as the registration position.

The display of the navigation system is used exemplarily as the display device. However, a head-up display may alternatively be used as the display device.

What is claimed is:

1. A consumable/wear part management device comprising:
a state acquisition unit for acquiring a consumed/worn state of a consumable/wear part;
a maintenance need determination unit for determining whether there is any consumable/wear part needing maintenance based on the consumed/worn state;
a margin determination unit for specifying a maintenance timing for maintenance of a consumable/wear part needing maintenance and determining a level of margin until a specified maintenance timing, in case of a determination that there is a consumable/wear part needing maintenance;
a driver determination unit for determining whether a driver is a vehicle administrator; and
a notification control unit for notifying maintenance information of the consumable/wear part needing maintenance, wherein
in case that the level of margin is equal to or higher than a prescribed value, the notification control unit notifies the maintenance information of the consumable/wear part needing maintenance if the driver is the vehicle administrator and no maintenance information if the drive is other than the vehicle administrator, and
in case that the level of margin is less than the prescribed value, the notification control unit notifies the maintenance information regardless of whether the driver is the vehicle administrator.

2. The consumable/wear part management device according to claim 1, wherein:
in case that the level of margin is less than the prescribed value, the notification control unit directly notifies the vehicle administrator of the maintenance information advising execution of maintenance if the driver is the vehicle administrator and indirectly notifies the vehicle administrator of the maintenance information advising execution of maintenance if the driver is other than the vehicle administrator.

3. The consumable/wear part management device according to claim 1, further comprising:
a notification condition determination unit for determining whether a notification condition is satisfied,
wherein, in case that the level of margin is equal to or higher than the prescribed value, the notification control unit notifies the maintenance information on condition that the notification condition is satisfied if the driver is the vehicle administrator.

4. The consumable/wear part management device according to claim 3, wherein:
the notification condition determination unit determines that the notification condition is satisfied in at least either one of cases that a lapse of time after the driver started a driving operation is less than a prescribed time or that a present position of the vehicle is a pre-registered position.

5. The consumable/wear part management device according to claim 1, further comprising:
a maintenance recommendation determination unit for determining whether there is any consumable/wear part which is other than the consumable/wear part needing maintenance and for which maintenance is recommended,
wherein the notification control unit notifies, in addition to notification of the maintenance information of the consumable/wear part needing maintenance, maintenance information of the consumable/wear part recommended for maintenance in case that there is a consumable/wear part recommended for maintenance.

6. A consumable/wear part management program for execution by a control unit of a consumable/wear part management device for managing a consumable/wear part of a vehicle, the consumable/wear part management program comprising:
state acquisition processing for acquiring a consumed/worn state of a consumable/wear part;
maintenance need determination processing for determining whether there is any consumable/wear part needing maintenance based on the consumed/worn state;
margin determination processing for specifying a maintenance timing for maintenance of a consumable/wear part needing maintenance and determining a level of margin until a specified maintenance timing, in case of a determination that there is a consumable/wear part needing maintenance;
driver determination processing for determining whether a driver is a vehicle administrator; and
notification control processing for notifying, in case that the level of margin is equal to or higher than a prescribed value, the maintenance information of the consumable/wear part needing maintenance if the driver is the vehicle administrator and no maintenance information if the drive is other than the vehicle administrator, and notifying, in case that the level of margin is lower than the prescribed value, the maintenance information regardless of whether the driver is the vehicle administrator.

7. A computer-readable non-temporary storage medium which stores the consumable/wear part management program according to claim 6.
